(19) United States
(12) Patent Application Publication
(10) Pub. No.: US 2017/0039283 A1
(43) Pub. Date: Feb. 9, 2017

(54) Searching Based on the Persona of Another

(71) Applicant: Microsoft Technology Licensing, LLC, Redmond, WA (US)

(72) Inventors: Paul N. Bennett, Redmond, WA (US); Emre M. Kiciman, Seattle, WA (US); Alexander Fishkov, Saint-Petersburg (RU)

(21) Appl. No.: 14/884,789

(22) Filed: Oct. 16, 2015

Related U.S. Application Data
(60) Provisional application No. 62/200,607, filed on Aug. 3, 2015.

(51) Int. Cl. G06F 17/30

(52) U.S. Cl. CPC G06F 17/30867; G06F 17/3053; G06F 17/30554; G06F 17/30528

(57) ABSTRACT

An efficient computer-implemented technique is described herein for allowing a searcher to access result items by taking into account the perspective of a beneficiary entity. In some cases, the beneficiary entity may correspond to another person besides the searcher who submits a query, on whose behalf the searcher is performing the search. The technique operates by leveraging the activity of a group of relevant users who have a similar demographic profile to the beneficiary entity, with respect to a topic of the query under consideration.

This application claims the benefit of U.S. Provisional Application No. 62/200,607 (the '607 Application), filed Aug. 3, 2015. The '607 Application is incorporated by reference herein in its entirety.

### BACKGROUND

A user who performs a computer-implemented search is often interested in researching a topic for the user's own benefit. For example, a user may investigate the gas mileage of a particular car because he or she is potentially interested in purchasing that car. But in other cases, a user may perform a search on behalf of another person (or a group of other people). For example, a husband may perform a search for the purpose of finding a gift that may be suitable for his wife. A daughter may perform a search regarding an ailment that afflicts her mother, and so on.

A search engine may provide unsatisfactory results when a user is performing a search on behalf of another person. As an overall consequence, the user may find it necessary to engage in an extended exploration process to discover relevant information. Such a tactic may involve the submission of multiple queries; through this process, the user attempts to converge on a useful body of information through trial and error. This tactic is problematic because the searcher makes inefficient use of his or her time, and may even fail to find relevant information. Further, the searcher wastes the resources of the computing system that performs the search.

### SUMMARY

A computer-implemented technique is described herein for allowing a searcher to efficiently access result items by taking into account the perspective of a beneficiary entity. In some cases, the beneficiary entity may correspond to another person besides the searcher, on whose behalf the searcher is performing the search.

In one manner of operation, the technique entails receiving a query submitted by the searcher via a user device. The technique then identifies a beneficiary entity (if any) associated with the query, to provide beneficiary information. The technique then identifies, based on the beneficiary information, at least one activity characteristic associated with a group of relevant users with respect to a topic of the query under consideration, to provide characteristic information. The group of relevant users corresponds to one or more searchers who have a similar demographic profile to the beneficiary entity with respect to the topic of the query. Finally, the technique identifies at least one result item (e.g., a search result item, an ad, a query suggestion, etc.) based on at least the query and the characteristic information, and then provides the result item(s) to the user's device.

For example, assume that a searcher is a daughter who has submitted at least one query on behalf of her mother, e.g., for the ultimate purpose of purchasing an item for her mother. The technique identifies the fact that the query is directed to a beneficiary entity, namely, the searcher's mother (more specifically, a woman of the same age group as the searcher's mother, not the searcher's mother per se). The technique can then identify the search-related activity of a group of users who are demographically related to the searcher's mother, where that activity is also relevant to the topic of the query under consideration. The technique then leverages the extracted characteristic information and any other constraints associated with the query to identify relevant result items.

In some implementations, the technique can identify the beneficiary entity associated with the query by automatically determining whether the query describes the beneficiary entity, either directly or indirectly.

In some implementations, the technique can confirm that the searcher is performing a search on behalf of another person by identifying a demographic profile associated with the searcher, to provide searcher information, and then determining whether the beneficiary information differs from the searcher information.

The above technique can be manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an overview of a system for facilitating searching on behalf of others.

FIGS. 2 and 3 show two respective examples of the use of the system of FIG. 1.

FIGS. 4 and 5 show two different ways of implementing any query processing component of the system of FIG. 1.

FIGS. 6 and 7 provide illustrative user interface presentations that may be generated by the system of FIG. 1.

FIG. 8 shows one implementation of a query analysis component, which is one component of the system of FIG. 1.

FIG. 9 shows one implementation of an activity-identifying component, which is another component of the system of FIG. 1.

FIG. 10 shows one implementation of a ranking component, which is another component of the system of FIG. 1.

FIG. 11 shows a process that represents one manner of operation of the system of FIG. 1.

FIG. 12 shows illustrative computing functionality that can be used to implement any aspect of the features shown in the foregoing drawings.

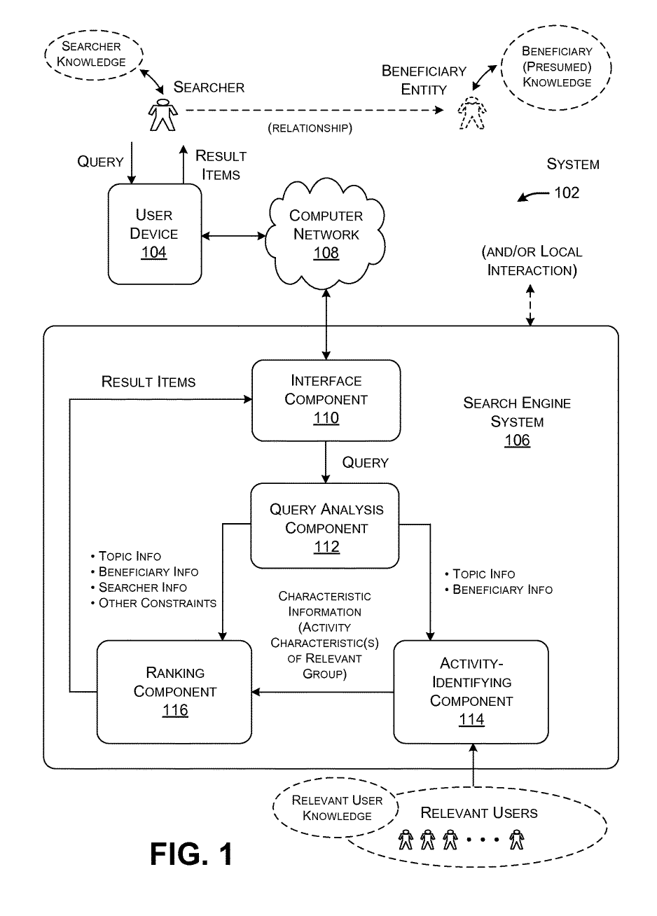

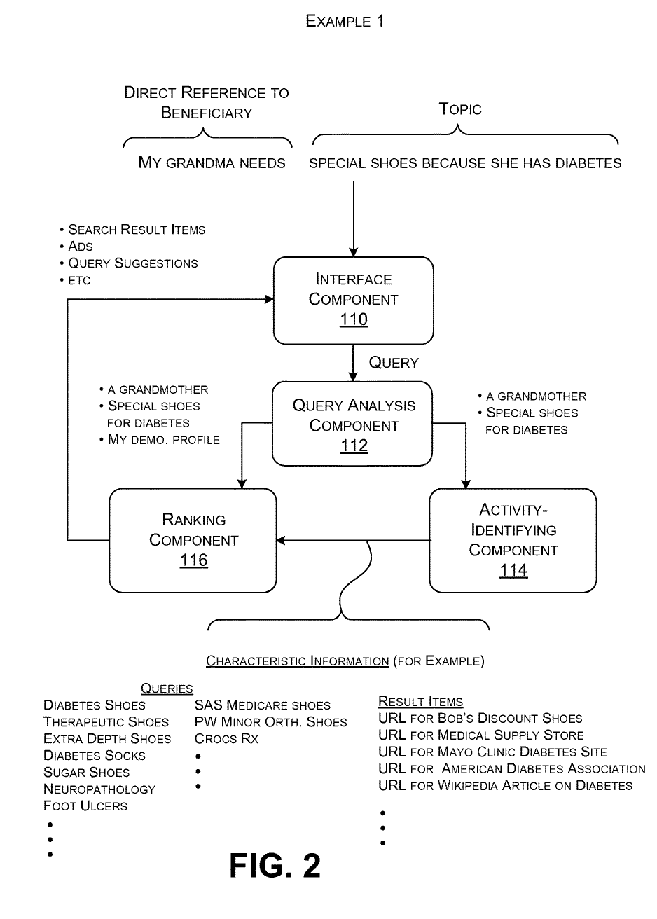

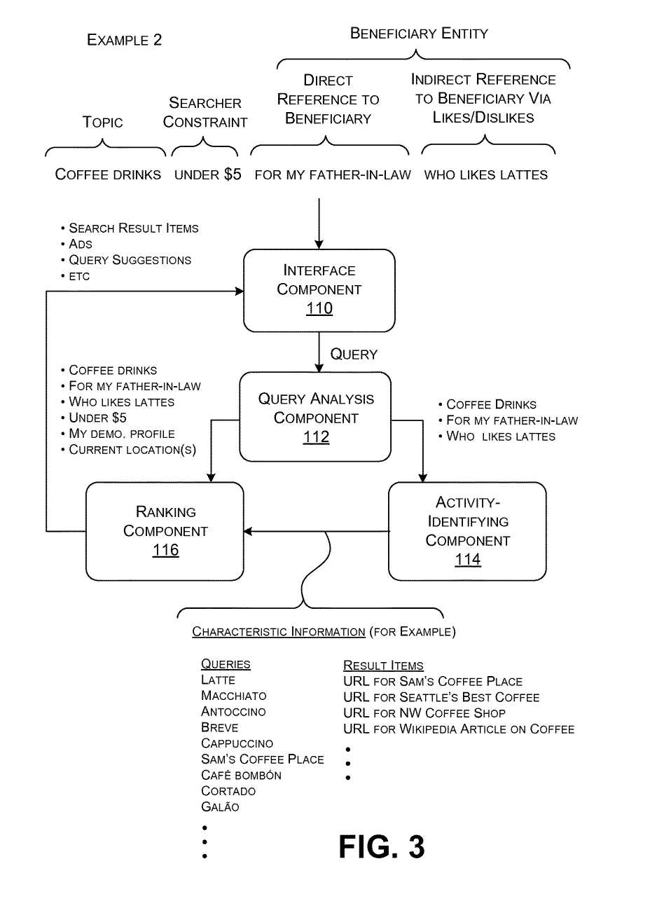

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes a computer-implemented system for facilitating searching on behalf of others. Section B sets forth illustrative methods which explain the operation of the system of Section A. And Section C describes illustrative computing functionality that can be used to implement any aspect of the features described in Sections A and B.

As a preliminary matter, some of the figures describe concepts in the context of one or more structural components, also referred to as functionality, modules, features, elements, etc. The various components shown in the figures can be implemented by various physical and tangible mechanisms, for instance, by software running on computer equipment, hardware (e.g., chip-implemented logic functionality), etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. Section C provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented by various physical and tangible mechanisms, for instance, by software running on computer equipment, hardware (e.g., chip-implemented logic functionality), etc., and/or any combination thereof.

As to terminology, the phrase “configured to” encompasses any way that various physical and tangible functionality can be constructed to perform an identified operation. The functionality can be configured to perform an operation using, for instance, software running on computer equipment, hardware (e.g., chip-implemented logic functionality), etc., and/or any combination thereof.

The term “logic” encompasses various physical and tangible functionality for performing a task. For instance, each operation illustrated in the flowcharts corresponds to a logic component for performing that operation. An operation can be performed using, for instance, software running on computer equipment, hardware (e.g., chip-implemented logic functionality), etc., and/or any combination thereof. When implemented by computing equipment, a logic component represents an electrical component that is a physical part of the computing system, however implemented.

Any of the storage resources described herein, or any combination of the storage resources, may be regarded as a computer-readable medium. In many cases, a computer-readable medium represents some form of physical and tangible entity. The term computer-readable medium also encompasses propagated signals, e.g., transmitted or received via a physical conduit and/or air or other wireless medium, etc. However, the specific terms “computer-readable storage medium” and “computer-readable storage medium device” expressly exclude propagated signals per se, while including all other forms of computer-readable media.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

A. Illustrative System

A.1. Overview

FIG. 1 shows a system 102 for processing a search that is submitted by taking into account the perspectival standpoint of a beneficiary entity. Information which describes the beneficiary entity is referred to herein as beneficiary information. Information which describes the searcher is referred to herein as searcher information.

In many cases, the beneficiary entity corresponds to another person (or group of people) compared to the person who has submitted the search (referred to herein as the searcher). For example, a searcher may perform a search with the intent of retrieving information that benefits a family member, friend, co-worker, or anyone else. In some such cases, the searcher may submit such a query with the ultimate objective of identifying a suitable gift for another person, and then purchasing that gift.

In other cases, a searcher may perform a search for his or her own benefit. For example, the searcher may know that a certain person (or class of people) is familiar with a search domain, even though the searcher is not familiar with that search domain. The searcher may overcome the deficiency in his or her personal knowledge by drafting a query that specifies a beneficiary entity who is familiar with the topic. Nevertheless, to facilitate explanation, it will henceforth be assumed that the beneficiary entity is another person (or another group of people) with respect to the identity of the searcher.

A searcher faces various challenges when searching on behalf of another person. For example, assume that the searcher wishes to purchase a gift for a friend who is an avid scuba diver, but the searcher has no familiarity with this activity. The searcher will likely therefore not understand the equipment and practices associated with scuba diving, together with the special terminology that is associated with this activity. Further, the searcher may have little insight into the particular needs of his or her friend. Further still, the searcher may not even understand where to go about learning more about the activity of scuba diving. As a consequence, the searcher may not know what terms to submit to the system 102. Further, the searcher may not know how to evaluate the result items provided by the system 102 (e.g., whether they represent relevant or irrelevant result items).

As a consequence of the above factors, without the provisions of the system 102, a traditional search engine system may provide unsatisfactory results. This may because the searcher has failed to enter useful queries. In addition, a traditional search engine system may assume, by default, that the searcher is performing a search to fulfill the searcher's personal needs. Hence, the traditional search engine system will automatically apply whatever knowledge it has regarding the personal needs, habits and demographics of the searcher in performing its search. As a result, a traditional search engine system may deliver result items that fail to satisfy the true objectives of the searcher in performing the search.

The system 102 addresses the above problem by automatically identifying the beneficiary entity associated with the searcher's query. The system 102 then identifies at least one characteristic of the prior search-related activity of a group of relevant users (corresponding to one or more of such users) who are demographically similar to the beneficiary entity, with respect to the topic of the query (such as scuba diving). This yields “characteristic information” according to the terminology used herein. And finally, the system 102 leverages the characteristic information, along with any other constraint(s) specified by the query, to identify relevant result items for presentation to the searcher.

To function in the manner described above, the system 102 also provides backend computer-implemented functionality to capture, analyze, and efficiently store characteristic information associated with different demographic groups, describing the prior search-related activity of those groups. In one implementation, for instance, the system 102 stores different tables associated with different respective topics. For each table, the system 102 provides characteristic information associated with different respective demographic groups, with respect to a topic associated with the table.

Overall, the system 102 automatically leverages the knowledge of a group of informed users when processing the searcher's query, even though the searcher may not possess that knowledge. In other words, the system 102 accomplishes a redirection or translation of perspective when performing a search; instead of performing a search from the standpoint of the searcher's own needs and habits and demographics (which is typical in the industry), the system 102 assumes that the search is to be performed from the standpoint of the beneficiary entity.

By generating and applying characteristic information in the above-summarized manner, the system 102 improves the relevance and usefulness of result items when a searcher happens to be performing a search based on a specified persona. For instance, in the above-cited example, the user who performs a search pertaining to scuba diving will receive relevant result items pertaining to this activity, despite the searcher's initial lack of knowledge regarding this activity. The accuracy of the system 102 also allows the searcher to find relevant result items in an expedited and efficient manner, resulting in improved user experience and the efficient use of computing and communication resources (e.g., by forgoing an extended search session which consumes system resources). Finally, all of the above-noted benefits to the searcher extend to the beneficiary entity, who receives the ultimate fruits of the search (e.g., corresponding to a gift, information, etc.).

The system 102 of FIG. 1 will now be described in greater detail below, generally in a top-to-bottom fashion. The description will then provide additional explanation of individual components which appear in FIG. 1 in respective subsections.

One implementation of the system 102 includes at least one user device 104 that is coupled to a search engine system 106 via a computer network 108. The searcher submits queries via the user device 104 and consumes result items from the search engine system 106 via the user device 104. Note that FIG. 1 shows a single representative searcher who interacts with a single user device 104, but the system 102 may generally allow a large number of searchers to interact with the search engine system 106 via respective user devices (not shown).

The user device 104 may correspond to any stationary or portable user device, including any of: a workstation computing device, a laptop computing device, a game console device, a set-top box device, a tablet-type computing device, a smartphone, a wearable computing device, and so on. The search engine system 106 can be implemented by one or more server computing devices and/or other computing equipment (e.g., load balancers, routers, switches, etc.). The computer network 108 may correspond to any wide area network (e.g., the Internet), a local area network, one or more point-to-point communication links, and so on, or any combination thereof.

In the example of FIG. 1, the search engine system 106 performs all of the processing of the searcher's query, and returns its results to the user device 104. In other implementations, any function performed by the search engine system 106 (to be described below) can alternatively, or in addition, be locally performed by the user device 104.

In another implementation, the search engine system 106 represents a local computing device, and a searcher can interact with the search engine system 106 in direct fashion (without the use of a separate user device 104 and the computer network 108). For example, the search engine system 106 may represent logic (e.g., a computer program) that runs on a user device. In that case, the user device may correspond to any type of computing device mentioned above.

An interface component 110 may provide one or more user interface presentations to the searcher's user device 104 that allow the searcher to enter a query. Subsection A.2 (below) provides representative examples of different kinds of user interface presentations that the interface component 110 can present for this purpose. The user, via the user device 104, may interact with the interface component 110 via a browser program, such as the INTERNET EXPLORER program, provided by MICROSOFT CORPORATION, of Redmond, Wash.

The interface component 110 also receives the searcher's query and performs initial processing on the searcher's query. The initial processing may entail filtering any query that is unlikely to be aimed at a beneficiary entity, and/or is otherwise problematic for one or more other reasons. For example, the interface component 110 can remove the query if it is directed to adult content or romance-related content. This type of query may be considered a non-complying query. The interface component 110 can optionally route any type of non-complying query to another component of the search engine system 106 (not shown), which is configured to handle that type of query.

In one implementation, the interface component 110 can perform the above filtering tasks using a rules-based and/or machine-learned classifier analysis engine; that classifier analysis engine determines whether or not the input query is a “persona query” that evinces an attempt to retrieve information by taking into account the perspective of a beneficiary entity, and whether that persona query also falls within an acceptable class of such “persona” queries. A query directed to adult subject matter would be a non-complying query, even if it is otherwise properly structured as a persona query. Alternatively, the classifier analysis engine can simply cull out queries directed to objectionable subject matter domains, without, at this juncture, determining whether the queries are persona queries. In other cases, any of the filtering functionality described above can alternatively, or in addition, be performed by later stages of the search engine system 106.

The interface component 110 also delivers output information that is generated by the search engine system 106 to the searcher's user device 104. The output information may provide any type of result items, including search result items, ads, query suggestions, and so on, or any combination thereof. Subsection A.2 (below) provides representative examples of different kinds of user interface presentations that the interface component 110 can present for this purpose.

Next, a query analysis component 112 parses the terms (e.g., words and phrases) in the query and classifies those terms. Subsection A.3 will provide a detailed description of this process. By way of introduction, the query analysis component 112 determines whether each term in the query describes a beneficiary entity, either directly or indirectly. A term may directly refer to a beneficiary entity by directly describing a demographic characteristic of the beneficiary entity. For instance, the term may specify a person by his or her age, gender, education level, etc. A term may indirectly refer to a beneficiary entity by describing a preference held by that beneficiary entity. For instance, the term may specify a like or dislike of the beneficiary entity.

The query analysis component 112 can also determine a topic associated with the query. The topic pertains to the subject matter to which the query pertains. For example, assume that the searcher is performing a search to find diabetic shoes for her grandmother. The topic of that search pertains to diabetic shoes. The query analysis component 112 can also identify any other constraint specified by the query. For example, assume that the searcher specifies that she is looking to purchase diabetic shoes under fifty dollars. The phrase “under fifty dollars” corresponds to a searcher constraint. It is a searcher constraint because it likely pertains to a preference of the searcher, not a qualification pertaining to the needs of the beneficiary entity. Finally, the query analysis component 112 can optionally determine searcher information, corresponding to any demographic information regarding the searcher (if available). For example, the searcher information may include any of the age, gender, etc. of the searcher.

To simplify explanation, the query analysis component 112 (and the system 102 as a whole) is described herein as performing its analysis on a query-by-query basis, e.g., by treating each query as a self-contained focus of analysis. In other cases, the query analysis component 112 can also take into consideration the search-related activity of a searcher over the course of the current session (or two or more sessions). For example, when evaluating the topic of the current query, the query analysis component 112 can take into consideration previous queries submitted by the same searcher in the same session.

Overall, the query analysis component 112 provides beneficiary information which encompasses all information in the query (if any) that pertains to the beneficiary entity. The query analysis component 112 provides topic information which describes the topic of the query. The query analysis component 112 provides other constraint information which describes any other constraint(s) in the query (such as searcher constraints). And the query analysis component 112 provides searcher information that describes the demographic profile of the searcher.

An activity-identifying component 114 next uses the beneficiary information and the topic information to identify a group of relevant users, where a group can include one or more of such users. The group of relevant users corresponds to one or more searchers who have a similar demographic profile to the beneficiary entity, with respect to the topic of the query. For example, again assume that the beneficiary entity corresponds to an elderly woman, and the topic of the query under consideration pertains to diabetic shoes. The group of relevant users in this case may correspond to a group of elderly women who have conducted searches on the topic of diabetic shoes. As will be described below in Subsection A.4, the activity-identifying component 114 can match the beneficiary information to the relevant group of users using a search filter having a degree of breadth (or fuzziness) that varies depending on the nature of the particular beneficiary entity and topic specified in the query and/or other factors. In some cases, a narrow match is appropriate; in other cases, a broader match is better. This also means that, in some implementations, what constitutes a similar demographic profile (between the beneficiary entity and another person) is a relative measure, determined by the distribution of activity information in a historical data set. In some cases, two people may have similar demographic profiles because they are both women. In other cases, two people may have a similar demographic profile because they are both women in the age range of 40-50 who live in Buffalo, N.Y.

The activity-identifying component 114 then retrieves at least one activity-identifying characteristic of the group of relevant users, to provide characteristic information. For example, the activity-identifying component 114 can retrieve the search queries that have been submitted by the relevant users to one or more computer-implemented information systems, where those search queries pertain to the topic of the query under consideration. In addition, or alternatively, the activity-identifying component 114 can identify search result items that are retrievable from the information systems on the basis of the queries. In addition, or alternatively, the activity-identifying component 114 can identify clicks (or other selections) made by the relevant users after having been presented with the search result items. In addition or alternatively, the activity-identifying component 114 can more generally retrieve the browsing actions made by the relevant users with respect to the topic of the query, and so on.

A ranking component 116 identifies one or more result item on the basis of the characteristic information provided by the activity-identifying component, together with any other information extracted by the query analysis component 112 (including topic information, beneficiary information, searcher information, other constraint information, etc.). As will be described more fully below in Subsection A.5, the ranking component 116 can identify the relevant item(s) using any ranking tactic. To cite merely one case, the ranking component 116 can use a fusion technique to identify a final set of search result items, culled from a plurality of subsets of candidate search result items associated with respective queries.

As noted above, the interface component 110 presents the result items to the searcher. In some cases, the result items correspond to one or more search result items, each of which identifies a network-accessible document or other content item. Alternatively, or in addition, the result items correspond to ads. Alternatively, or in addition, the result items correspond to query suggestions, and so on.

FIG. 2 shows a first example of the use of the system 102. Here, the searcher enters the query, “My grandma needs special shoes because she has diabetes.” Assume that searcher is a woman in her twenties, and that she is performing the search on behalf of her grandmother because her grandmother cannot or will not perform the search herself. But further assume that the searcher is not currently familiar with the way that diabetes may affect the feet of someone afflicted with this disease. And hence, the searcher is not immediately familiar with the proper terminology to use in constructing her search.

The interface component 110 receives the searcher's query and determines that it does not fall within a prohibited class of queries. The query analysis component 112 then parses the query to identify the beneficiary entity (“a grandmother”) and the topic of the query (“special shoes for diabetes”). The activity-identifying component 114 retrieves characteristic information pertaining to a relevant group of users. These users may correspond to elderly women who have previously conducted searches pertaining to diabetic shoes. Finally, the ranking component 116 uses the characteristic information, together with any other information extracted by the query analysis component 112, to identify one or more relevant result items.

Through interaction with the search engine system 106, the searcher may learn that the shoes that she is investigating are variously referred to as “diabetes shoes,” “therapeutic shoes,” “sugar shoes,” and so on. The searcher may also learn that many elderly women purchase such shoes at an establishment named “Bob's Discount Shoes” or a nearby medical supply store. The searcher may also learn of particular brands of shoes that many of the relevant searchers have mentioned, such as “SAS Medicare shoes,” “PW minor orthopedic shoes”, “Crocs Rx,” etc. The searcher may also learn of sites that provide a general education regarding the way that diabetes can affect the feet of someone afflicted by this disease. All such information reflects the collective insights of the group of relevant users—knowledge which the searcher did not possess prior to performing the search. Further note that, by leveraging a group of similar users who may experience many of the same challenges as the beneficiary entity, the system 102 is not only able to find relevant results about diabetic shoes, but can also place emphasis on shoes that are appropriate for use by the elderly for other reasons, e.g., because they help prevent falls (that is, because they offer good grip, low heel height, etc.).

FIG. 3 shows a second example of the use of the system 102. Here, the searcher enters the query, “Coffee drinks under $5 for my father-in-law who likes lattes.” Assume that the searcher is a man in his forties, and that he is performing the search on behalf of his father-in-law. The searcher's ultimate objective is to find a coffee shop with an unusual coffee-drink specialty where he can take his father-in-law. The searcher himself, however, may not be a coffee drinker. His knowledge prior to conducting the search may therefore be limited to the fact that he has observed his father-in-law drinking different kinds of coffee with milk; a latte is the only specific drink he can remember.

The interface component 110 receives the searcher's query and determines that it does not fall within a prohibited class of queries. The query analysis component 112 then parses the query to identify the beneficiary entity (“my father-in-law who likes lattes.”) More specifically, the query analysis component 112 identifies the phrase “my father-in-law” as a part of the query that makes direct reference to the demographic characteristics of the beneficiary entity. The query analysis component 112 identifies the phrase “who likes lattes” as information which indirectly refers to the beneficiary entity with respect to the tastes of the beneficiary entity. In other cases, the searcher could have constructed the query by omitting the phrase “for my father-in-law,” and by specifying the beneficiary entity using only the phrase “people who like lattes” or the like. Finally, the query analysis component 112 can extract the topic of the query (“coffee drinks”) together with the searcher constraint of “under 5$.” The searcher enters the searcher constraint because he does not wish to spend more than five dollars on the gift to his father-in-law.

The activity-identifying component 114 then retrieves characteristic information which pertains to the search-related activity of a group of relevant users, with respect to the topic of coffee drinks In a first case, the activity-identifying component 114 may narrowly construe the beneficiary entity's presumed age range and gender. As a result, the activity-identifying component 114 will identify a group of relevant users that have the same gender and same age range as the identified beneficiary entity. Alternatively, the activity-identifying component 114 may conclude that the search-related activity of coffee drinkers does not vary much with respect to gender and with respect to certain large swathes of ages (e.g., from ages 30 to 60). If this is true, the activity-identifying component 114 may provide a more liberal filter in defining the relevant group of users. The degree of fuzziness in performing this match generally depends on the topic and beneficiary entity under consideration.

The ranking component 116 uses all of the information that has been determined (the characteristic information, the topic information, the beneficiary information, the searcher information, the further constraint information, etc.) to identify one or more result items. In addition, the ranking component 116 can take into consideration the location of the searcher at the present time, e.g., for the purpose of emphasizing coffee shops that are nearby the searcher at the present time. The location of the searcher can be determined using any known position-determination mechanism(s), such as a Global Positioning System mechanism, a hotspot proximity mechanism, a radio tower triangulation mechanism, and so on.

In the second example, the searcher may learn the names of several coffee drinks that include milk, many of which he has never heard of before. The searcher also learns of the location of one or more nearby coffee shops where he can purchase one of these coffee drinks for his father-in-law. The father-in-law may be pleased by the gift, especially since it matches his likes, and suggests thoughtfulness on the son-in-law's part.

At least some of the above-identified processing components of FIG. 1 can be implemented by one or more computer-implemented analysis engines. For instance, in one implementation, a first analysis engine may implement the filtering operation of the interface component 110, a second analysis engine may implement the parsing and classification operation of the query analysis component 112, a third analysis engine may implement the activity extraction operation of the activity-identification component 114, and a fourth analysis engine may implement the ranking operation of the ranking component 116. In another implementation, a single analysis engine can implement the functions of two or more of the above-mentioned components. For example, a single analysis engine can perform the activity extraction operation of the activity-identifying component 114 and the ranking operation of the ranking component 116. Indeed, in one implementation, the search engine system 106 can be implemented by a single analysis engine.

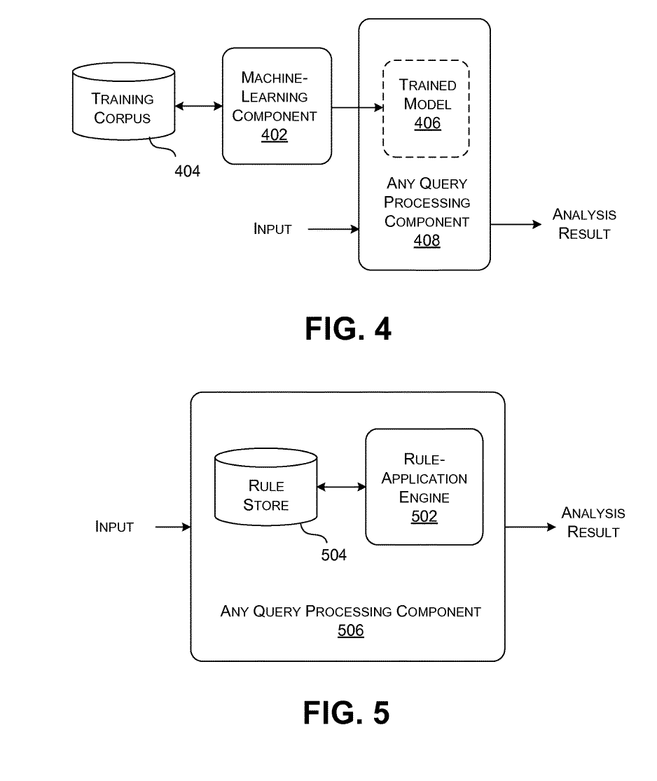

Any individual analysis engine can be implemented in any manner. For example, advancing to FIG. 4, this figure shows a machine-learning component 402 that operates (in an offline process) on a corpus of labeled training examples (in a data store 404) to produce a trained model 406. The machine-learning component 402 can use any machine-learning technique to produce any corresponding machine-learned model, such as by applying, without limitation, any of: a Conditional Random Fields (CRF) technique; a regression technique (such as a logistic regression technique); a support vector machine technique; a nearest neighbor technique; a decision tree technique; a clustering technique; a neural network technique; a Bayesian network technique; and so on. A query processing component 408 corresponds to any individual component of the system 102 of FIG. 1. The query processing component 408 uses the trained model 406 to process the query. For example, assume that the query processing component 408 corresponds to the query analysis component 112 or part thereof. In that context, the query processing component 408 may use an appropriately trained model 406 to identify parts of the query that describe a beneficiary entity.

Alternatively, FIG. 5 shows a rule-application engine 502 and an associated collection of rules (in a data store 504) for implementing the logic associated with a query processing component 506. The rule-application engine 502 can be implemented using any rule-based technology, such as an engine which applies a collection of if-then rules, an artificial intelligence engine, etc. An if-then rule maps a particular input condition (such as the appearance of particular keywords in the input query) to a particular analysis result. The query processing component 506 again corresponds to any part of the system 102 of FIG. 1. For example, again assume that the query processing component 408 may correspond to the query analysis component 112. In that context, the query processing component 508 uses a plurality of discrete rules to determine whether a term of a query corresponds to a beneficiary entity.

Note that the application of the technology described in FIGS. 4 and 5 to the query analysis component 112 (and to the recognition of beneficiary entities) is merely representative; any other component of the system 102 can be implemented using similar technology, e.g., using a machine-trained model that is produced based on labeled training examples, and/or a rules-based system that relies on a set of discrete rules.

A.2. Interface Component

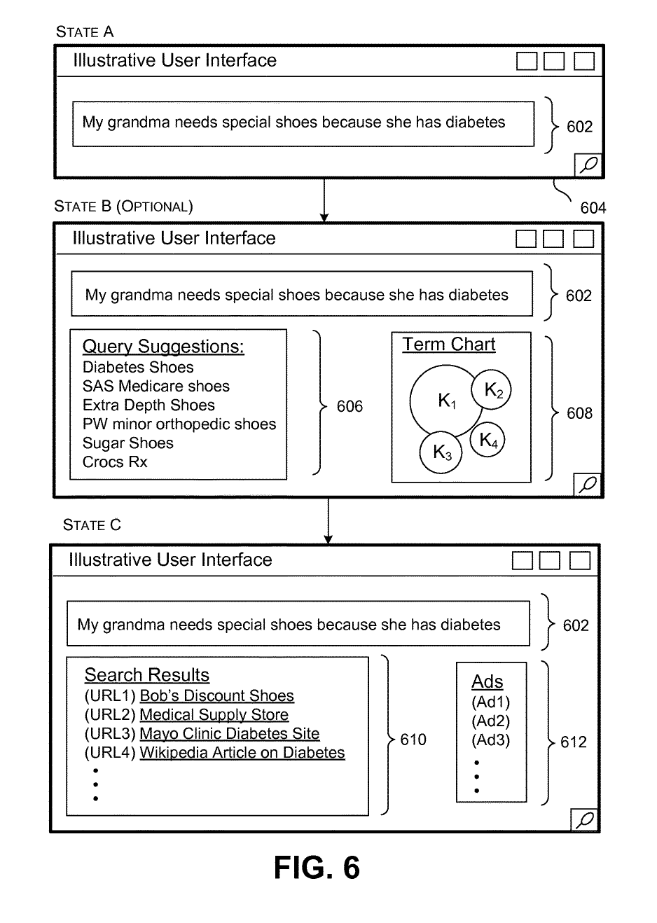

FIG. 6 shows a series of user interface presentations that the interface component 110 can present to the searcher via a graphical user interface provided by the user device 104. In state A, the searcher inputs her query (“My grandma needs special shoes because she has diabetes”) into an input field 602 of a user interface presentation 604.

In state B, the interface component 110 optionally provides a list of one or more query suggestions 606. Each query suggestion constitutes a result item that is identified by the ranking component 116. The ranking component 116, in turn, can generate the query suggestions 606 on the basis of the characteristic information provided by the activity-identifying component 114; these queries may correspond to actual queries submitted by users in the group of relevant users. The searcher may optionally use the query suggestions as guidance in revising her query. The interface component 110 can optionally also provide any other information that assists the searcher in revising her query. For example, the interface component 110 can provide a term chart 608 of any type which identifies the relative popularity of search terms among the relevant users.

In state C, the interface component 110 returns a set of one or more search results items 610 that are relevant to the query. Each search result item may identify a network-accessible site or other network-accessible content item. The searcher may click on or otherwise activate a search result item to visit its associated network-accessible site. In addition, or alternatively, the interface component 110 can return a set of one or more ads 612 that are relevant to the query.

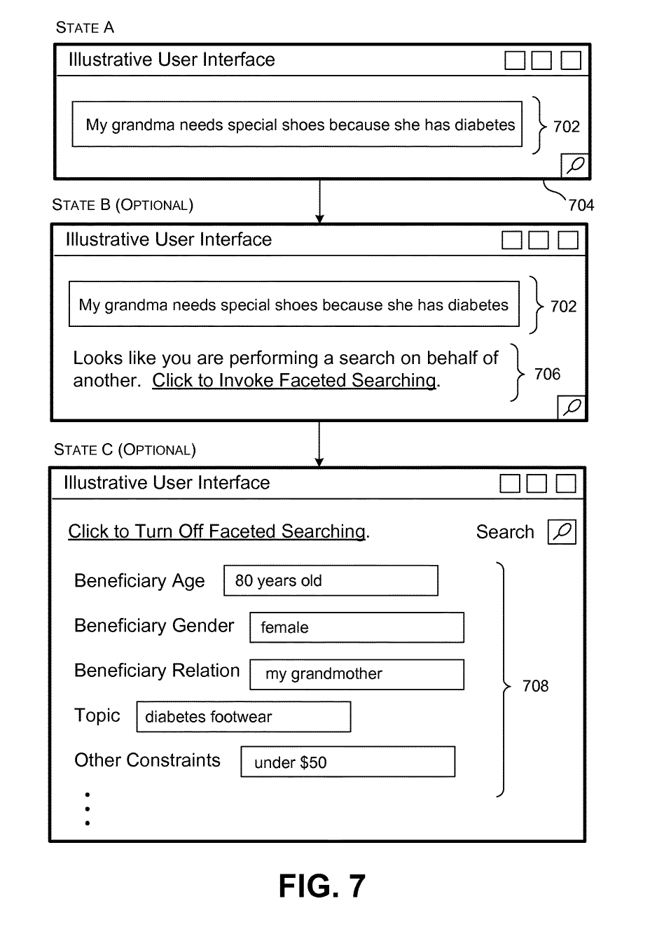

In the example of FIG. 7, in state A, the searcher again enters the query “My grandma needs special shoes because she has diabetes” into an input field 702 of a user interface presentation 704. In response, the query analysis component 112 again concludes that the searcher appears to be constructing a query that is directed to a beneficiary entity.

In state B, the interface component 110 displays a message 706 that asks the searcher whether she wants to alternatively specify her query using a faceted input interface. In other cases, the user interface component 110 can allow the searcher to manually activate the faceted input interface prior to constructing a query, that is, without being invited by the interface component 110 to do so.

In state C, the interface component 110 provides a faceted input interface having a collection of input fields 708. For example, a first input field allows the searcher to explicitly and manually specify the approximate age of the beneficiary entity. A second input field allows the searcher to specify the gender of the beneficiary entity. A third input field allows the searcher to specify the relationship between herself and the beneficiary entity, and so on. Different implementations can provide a different collection of input fields. Further, the interface component 110 can tailor its collection of input fields to the nature of the query that the searcher initially specified in the input field 702. Further, different implementations can use different graphical control features to collect search values, such as checkboxes, radio buttons, drop-down menus, slider input features, and so on.

A.3. Query Analysis Component

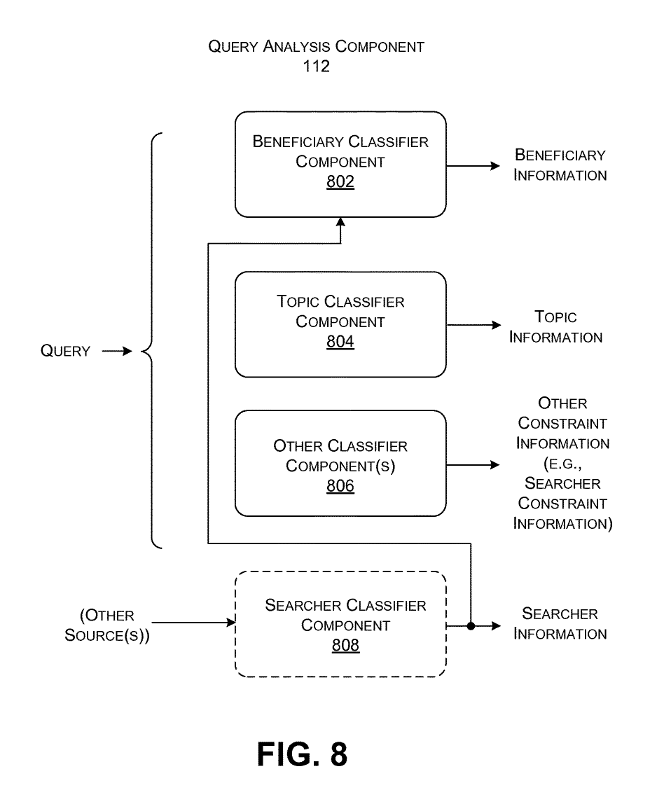

FIG. 8 shows one implementation of the query analysis component 112. In part, the purpose of the query analysis component 112 is to classify each part of the input query. To perform this task, the query analysis component 112 can decompose the query into its constituent terms (e.g., words or phrases or other tokens) and then classify each term.

More specifically, a beneficiary classifier component 802 determines whether a query term under consideration describes a beneficiary entity, to provide beneficiary information. A topic classifier component 804 determines whether a query term under consideration describes a topic, to provide topic information. The topic classifier component 804 can also identify the most likely topic specified by a query term. In other cases, the topic classifier component 804 can identify the n most likely topics specified by a query term, and can specify a probabilistic weight associated with each classification. Further note that a query can contain two or more terms that specify two or more respective topics. However, to simplify the explanation, it will henceforth be assumed that that the query specifies a single topic, and that the topic classifier component 804 identifies the single most likely classification of that topic. Finally, an “other classifier” component 806 determines whether a query term under consideration corresponds to an “other constraint,” such as in the searcher constraint “under $5” specified in example 2. The “other classifier” component 806 yields other constraint information.

An optional searcher classifier component 808 determines at least one demographic characteristic of the searcher who has submitted the query (such as gender, age, education level, political affiliation, etc.), to provide searcher information. The searcher classifier component 808 can make this determination based on demographic information that is explicitly supplied by the searcher, e.g., in a setup routine or the like. Alternatively, or in addition, the searcher classifier component 808 can infer the demographic characteristic(s) of the searcher based on the previous online activity of the searcher. For example, assume that the searcher repeatedly visits a network-accessible site that emphasizes women-related issues (such as the website Jezebel); here, the searcher classifier component 808 can conclude that the searcher is probably a woman.

FIG. 8 also shows that the output of the searcher classifier component 808 may feed into the input of the beneficiary classifier component 802. Based on this input, the beneficiary classifier component 802 can provide a more fine-grained analysis by determining whether the searcher is likely to be conducting a search on behalf of another person (as opposed to himself or herself). That is, the beneficiary classifier component 802 can determine the difference between the searcher information and the beneficiary information; when there is sufficient variance in these two pieces of information, the beneficiary classifier component 802 concludes that the target of the search is not the searcher.

As noted above in Subsection A.1, each subcomponent shown in FIG. 8 can be implemented using any type of analysis engine, such as machine-trained analysis engine, a rules-based analysis engine, or a combination thereof. Alternatively, a single analysis engine can be used to implement two or more subcomponents shown in FIG. 8. For example, a single machine-trained Conditional Random Fields (CRFs) engine can be used to probabilistically assign different tags to the terms in the query. The tags correspond to, respectively, beneficiary entity, topic, and searcher constraint, etc. More formally stated, a CRF model provides the most probable slot sequence defined by: Ŷ=argmax_{Y} p(Y|X), where X refers to the sequence of tokens in a query (x₁, x₂, . . . , x_{T}) and Y refers to the sequence of tags (y₁, y₂, . . . , y_{T}) assigned to the tokens, where the tags are selected from a set C of possible tags.

For the case of a machine-trained analysis engine, the offline machine-learning component 402 (of FIG. 4) produces a machine-trained model 406 based on a corpus of appropriately labeled training queries. For example, the beneficiary classifier component 802 can use a model that is produced based on corpus of training examples, where each term of each training example is labeled to indicate whether or not it pertains to a beneficiary entity. Similarly, the topic classifier component 804 can use a model that is produced based on a corpus of training examples, where each term of each training example is labeled to indicate its topical classification.

In the case of a rules-based analysis engine, any classifier component uses a set of discrete rules to classify a query term. For example, the beneficiary classifier component 802 can conclude that a query term directly describes a beneficiary entity when it matches one or more phrase templates, as in the pattern “for <person>,” or the pattern “<person> needs” or “<person> wants,” etc., where <person> refers to a specific person or class people using keywords such as girl, boy, woman, man, senior, mother, father, son, daughter, aunt, uncle, grandmother, grandfather, person, people, etc. The beneficiary classifier component 802 can determine that a query term is referring to an age when it matches patterns such as “<number> years old” or “<number> yo,” etc., where <number> refers to a numeric age. The beneficiary classifier component 802 can determine that a query term is indirectly referring to a beneficiary entity when it includes keywords such as “like” or “dislike.” The other classifier component 806 can determine that a query term specifies a searcher constraint when it includes phrases like “under <dollar amount>,” and so on. The topic classifier component 804 can conclude that a query term describes a topic by process of elimination, e.g., because it does not refer to a beneficiary entity, a searcher constraint, or a throw-away preposition, conjunction, etc.

As noted above, the query analysis component 112 has been described herein as providing analysis on a query-by-query basis, where each query represents a self-contained focus of investigation. In another case, the query analysis component 112 can also take into consideration the activity of a searcher over an entire search session, or potentially over two or more search sessions. For example, to determine whether a query term describes a beneficiary entity, the beneficiary classifier component 802 can also take into account the content of the queries that the searcher has previously submitted during the present search session. The beneficiary classifier component 802 can also take into consideration the search result “clicks” and browsing actions of the searcher within the present search session.

A.4. Activity-Identification Component

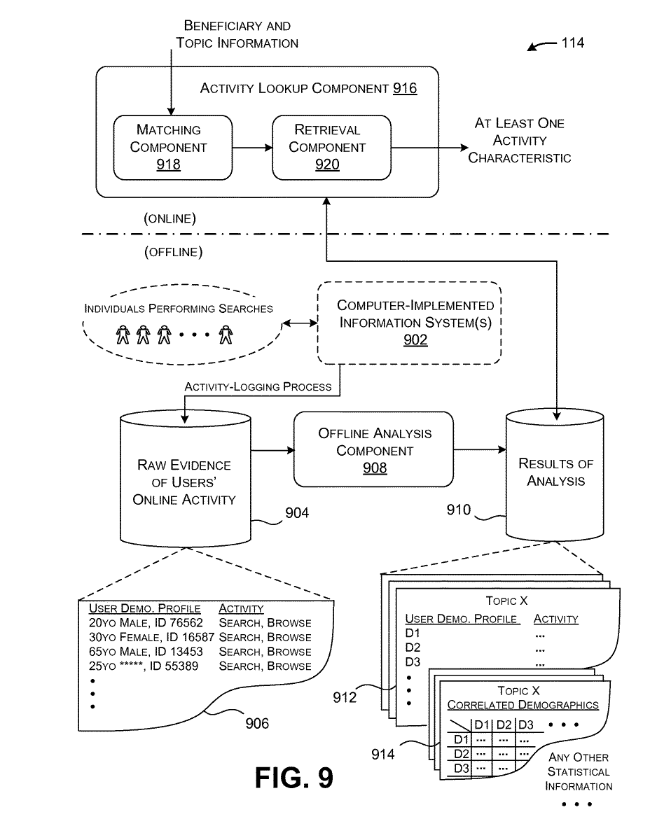

FIG. 9 provides further details regarding one implementation of the activity-identifying component 114. Recall that the purpose of the activity-identifying component is to map the topic information and beneficiary information to characteristic information. The characteristic information, in turn, sets forth at least one characteristic of the search-related activity of a group of relevant users, with respect to the topic under consideration. These users are relevant because they have a similar demographic profile to the beneficiary entity, with respect to the topic under consideration.

The activity-identifying component 114 can include some functionality which operates in an offline manner, and some functionality that operates in an online manner. The offline functionality operates in a preparatory phase, not in dynamic response to the searcher's submission of a query. The online functionality operates in dynamic response to the query. Generally, different implementations can make different choices as to functions that are performed offline and online. The following explanation corresponds to one allocation of functions among many.

Referring first to the offline functionality, assume that the activity-identifying component 114 (or some other component, not shown) monitors the search-related activity of a group of individuals, with respect to one or more computer-implemented information systems 902. The computer-implemented information systems 902 may correspond to one or more commercial search engines or the like. The individuals may have different respective demographic profiles (e.g., different ages, genders, income levels, likes, dislikes, habits, etc.). Generally, the terms “demographic” and “demographic profile” refer to any characteristic or combination of characteristics associated with a person, rather than to any fixed set of characteristics. In other words, different implementations of the system 102 can leverage different characteristics.

In operation, the activity-identifying component 114 can record the queries submitted by these individuals over a span of time to the information systems 902. In addition, or alternatively, the activity-identifying component 114 can store the search result items returned by the information systems 902 in response to those queries, along with the ranking weights associated with those respective search result items assigned by the information systems 902. In addition, or alternatively, the activity-identifying component 114 can store the selections made by the individuals within the search result items served by the information systems 902. In addition, or alternatively, the activity-identifying component 114 can more generally record the browsing activity of the individuals over a span of time. The activity-identifying component 114 can record all such activity information in one or more data stores 904.

In addition, the activity-identifying component 114 can annotate each item of activity information in the data store(s) 904 with demographic information. The demographic information describes one or more demographic characteristics of the person who is attributed to the item of activity information under consideration. For example, assume that a woman in her sixties submits a particular query for “diabetic shoes.” The data store(s) 904 can register this query, along with information regarding the demographic profile of the person who performed this search. FIG. 9 shows a simplified snapshot 906 of some of the information that may be stored in the data store(s) 904.

In some cases, the activity-identifying component 114 can collect the demographic information based on information that each individual explicitly provides, e.g., by filing out a questionnaire or the like. Alternatively, or in addition, the activity-identifying component 114 can infer the demographic information of the individuals based on their online search and/or browsing activity. Generally, each individual may provide explicit authorization to the activity-identifying component 114 that permits it to collect the above-described activity-related and demographic information, and may be monetarily compensated for providing that authorization

An offline analysis component 908 (also referred to as just an “analysis component” herein because it can operate in a dynamic online mode) processes the raw information in the data store(s) 904 to produce higher-level summary information. The offline analysis component 908 can then store the results of its analysis in a data store 910. Generally, the offline analysis component 908 can produce summary information in different ways. Without limitation, the following explanation represents one manner of generating summary information among many.

In one implementation, the offline analysis component 908 can identify a finite universe of n topics to be considered. This finite universe may correspond to a set of all topics that were observed in the logged activity information provided in the data store 904. For instance, “diabetic shoes” corresponds to one topic, while “coffee drinks” corresponds to another topic. For each topic, the offline analysis component 908 then extracts the activity of the individuals who have investigated this topic. The offline analysis component 908 can then organize this activity into demographic groups with respect to each topic under consideration. Each group corresponds to a collection of people who have a similar demographic profile. The offline analysis component 908 can then store a table (and/or some other data structure(s)) for each topic that maps each demographic group to its associated activity. For example, the snapshot 912 shows a simplified excerpt of one such table for a topic x.

A demographic group (and a corresponding demographic profile) can be defined with respect to any demographic characteristic or combination of characteristics of users. In one example, for a particular table, the offline analysis component 908 can allocate a series of groups to different respective male age ranges and female age ranges. Alternatively, or in addition, the offline analysis component 908 can allocate a series of groups to different geographic locations associated with users. Alternatively, or in addition, the offline analysis component 908 can allocate a series of groups to different prevalent interests, habits, etc. of the users, and so on.

Optionally, the offline analysis component 908 can also perform cluster analysis to determine the granularity at which groups are defined along one or more dimensions of demographic information. Cluster analysis operates by identifying groups that exhibit similar search-related activity with respect to each topic under consideration. As a result of such analysis, the offline analysis component 908 can form some tables that exhibit a fine-grained distribution of demographic groups. The offline analysis component 908 can form other tables that have fewer and broader groups. For example, the offline analysis component 908 may conclude that the search topic “bracelet” is strongly correlated to gender, but not very strongly correlated to different adult age ranges. In response, the offline analysis component 908 may potentially allocate only two groups for this topic, a first for male users and a second for female users. In contrast, the offline analysis component 908 can conclude that the search “hearing aid” is strongly correlated to age, but not very strongly correlated to gender. In response, the offline analysis component 908 can potentially allocate a series of groups for different age groups which do not distinguish between male and female users. The offline analysis component 908 may conclude that the topic “coffee drinks” varies insignificantly with respect to both different adult age groups and gender. In response, the offline analysis component 908 can potentially form groups associated with other differentiating characteristics, such as the prevalent interests of the users.

In addition, the offline analysis component 908 can perform the above-described cluster analysis with respect to topics. For example, assume that the offline analysis component 908 determines that people exhibit similar search-related activity when searching for wines of different types. If so, then the offline analysis component 908 can generate a single topic table for all wines. Alternatively, assume that the search-related activity of people who search for Cabernet Sauvignon differs from the activity of people searching for White Zinfandel; in that case, the offline analysis component 908 may create two respective topic tables for these wines.

In yet an alternative implementation, the offline analysis component 908 does not perform any of the above-described cluster analysis. In such an implementation, the offline analysis component 908 forms topic tables that include the same allocation of predefined demographic groups. For example, each topic table can include a first set of groups associated with predefined male age ranges, and a second set of groups associated with predefined female age ranges.

The offline analysis component 908 can also optionally precompute and store aggregate information for each topic and demographic group. For example, assume that the offline analysis component 908 determines that a particular demographic group has submitted p unique queries when searching a particular topic x, and visited a total of q unique network-accessible sites as a direct result of submitting the queries. The offline analysis component 908 can determine the number of times these people have submitted each such query, and the number of times that the people have visited each network-accessible site.

In addition, or alternatively, the offline analysis component 908 can generate statistical information which indicates the extent to which one demographic group submits queries for the benefit of another demographic group, both overall (without respect to topic), and on a topic-by-topic basis. The snapshot 914, for instance, identifies the correlation between people making searches (along the vertical axis) and beneficiary entities identified in those searches (along the horizontal axis), with respect to a topic x, and with respect to a plurality of different demographic groups (D1, D2, D3, etc.).

The system 102 can make use of the above-described type of cross-demographic analysis in different ways. For example, the beneficiary classifier component 802 can leverage this kind of statistical information to help determine the probability that a particular searcher is attempting to craft a query for the benefit of another person. In addition, if so permitted by the individuals whose activity has been captured, an administrator of the system 102 can offer the statistical information to interested parties (e.g., advertisers) on a pay-for-use basis or any other basis.

In yet other cases, note that the system 102 can import the information provided in data store 910 from a third-party provider, e.g., without itself conducting the offline analysis described above. In all cases, the system 102 provides appropriate safeguards that prevent any searcher (or anyone else) from discovering a nexus between the statistical information provided in the data store 910 and the activity (or personal information) of any one individual. Such safeguards can include, for instance, data sanitizing mechanisms that strip off personal information (such as ID numbers, account numbers, etc.) specified in queries.

Now referring to the online phase of analysis, when a searcher submits a particular query, an activity lookup component 916 can map the topic information and beneficiary information (identified by the query analysis component 112) to particular characteristic information. The activity lookup component 916 extracts the characteristic information from the data store 910, which has been computed as part of the offline process. Alternatively, the activity lookup component 916 can perform any of the offline analysis described above as part of the online process. For example, assume that the query specifies a topic for which a table does not yet exist. The activity-identifying component 114 can handle this scenario by performing an open-domain extraction and matching operation.

More specifically, a matching component 918 first maps the topic information and the beneficiary information to one of the tables maintained in the data store 910. For example, assume that the search inputs a query, “fishing lures for my 70 year old grandfather.” The matching component 918 can identify a relevant table associated with the topic “fishing lures,” together with a relevant demographic group within that table (that encompasses seventy year old men). In one case, the matching component 918 can performing this mapping task using a machine-trained model and/or a rules-based analysis engine. Having located an appropriate table and demographic group, a retrieval component 920 can then retrieve the characteristic information from an appropriate entry within that table. In other cases, the retrieval component 920 can retrieve characteristic information from multiple entries in a table, as when the query specifies ages greater than thirty.

Consider now the special case in which the searcher's query specifies the beneficiary entity indirectly, e.g., by specifying “cookware for someone who likes Thai food.” In one technique, the activity-identifying component 114 can address this query by accessing a table pertaining to the topic of cookware. Assume that the cookware table already devotes different demographic groups to people who like different respective ethnic cuisines, including a group associated with people who like Thai food. In this case, the activity-identifying component 114 can retrieve characteristic information from the Thai group. In other cases, assume that the cookware table does not store a precomputed Thai group. The activity-identifying component 114 can handle this situation in different ways. In one case, the activity-identifying component 114 can form a Thai group (with respect to the topic of cookware) in a dynamic online manner. In another case, the activity-identifying component 114 can consult a pre-existing topic table for Thai cuisine to determine an extent to which different demographic groups perform searches pertaining to Thai food. Assume, hypothetically, that it is determined that Thai food is most popular for men and women from ages 30 to 50. The activity-identifying component 114 can then extract the characteristic information from the appropriate demographic entry (for ages 30-50) in the cookware table. In another case, the activity-determining component 114 can extract the characteristic information from the cookware table which appears to pertain to Thai cuisine, e.g., as evidenced by keywords pertaining to Thai food.

Next consider the case in which the searcher's query reads “cookware for a woman over 50 who likes Thai food.” Assume that the table on cookware stores groups for different age ranges, and also stores groups for different ethnic food preferences. In one technique, the activity-identifying component 114 can retrieve the characteristic information from the groups associated with women over 50. The activity-identifying component 114 can also retrieve the characteristic information from the group(s) associated with Thai cuisine. The activity-identifying component 114 can then form a master set of characteristic information by forming a union or intersection (or any other logical combination) of the retrieved characteristic information. In another implementation, the activity-identifying component 114 can dynamically form a group pertaining to women over 50 who like Thai food, with respect to the topic of cookware. In another implementation, the activity-identifying component 114 can retrieve the characteristic information from the appropriate age-related demographic group(s) in the cookware table, and then elevate the importance of any of that characteristic information that also pertains to Thai food, e.g., as evidenced by keywords pertaining to Thai food.

The above explanation also highlights the point that what is considered a group of relevant users need not map to any single group in a single table in a direct one-to-one manner. For example, when the query specifies the beneficiary entity with respect to “women over 50,” the group of relevant users may correspond to a union of appropriate groups in a particular topic table.

Overall, the functionality of FIG. 9 provides a technique for surfacing and then leveraging search-related activity patterns associated with different demographic groups in a reliable, resource-efficient, cost-efficient, and expeditious manner. For instance, the functionality of FIG. 9 can produce gains in efficiency and reliability by dispensing with (or minimizing reliance on) ad hoc manual analysis. The functionality produces further gains in efficiency through the compact (yet readily accessible) manner in which it represents the activity patterns in the above-described tables (and/or other data structures).

A.5. Ranking Component

The ranking component 116 identifies one or more result items (such as search result items, ads, query suggestions, etc.) based on the characteristic information (supplied by the activity-identifying component 114), and any information identified by the query analysis component 112 (such as the topic information, the beneficiary information, the searcher information, the other constraint information, etc.).

The ranking component 116 can be implemented by one or more analysis engines of any type described above, such as a rules-based analysis engine, a machine-trained model, and so on. For example, in one case, the ranking component 116 can use a single machine-trained model or rules-based analysis engine to perform its ranking operation. In other implementations, the ranking component 116 can use a staged approach, where the conclusions of one analysis engine may provide input to one or more downstream analysis engines.

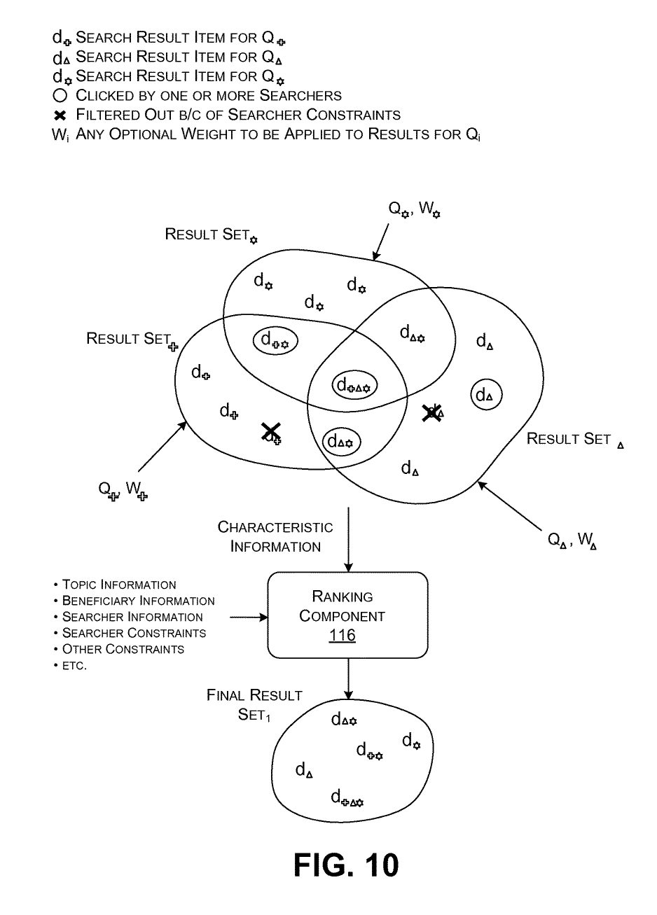

The ranking component 116 can use many different techniques to identify the result items. Without limitation, FIG. 10 shows one technique. Here, assume that the characteristic information identifies at least three queries. Further assume that each query is associated with a result set, containing search result items that can be retrieved by a search engine on the basis of the submitted query. Further, the characteristic information may describe a rank assigned to each search result item by the search engine. Further, the characteristic information may indicate the number of times that the relevant users clicked on the search result items, in response to being served those items by the search engine, and so on.

In one case, the ranking component 716 can determine the popularity of each query, corresponding to the number of times that the relevant users have submitted that query. The ranking component 716 can then select a subset of the most popular queries and offer those queries to the searcher as query suggestions (as shown in state B of FIG. 6).

Alternatively, or in addition, the ranking component 116 can identify those queries which most distinguish the beneficiary class's searches on a topic (e.g., “fishing lures”) from the searches of other classes. For example, if a 70 year old's fishing lures are mostly similar to everyone else's fishing lures, the ranking component 116 can highlight the few fishing lures that are distinctive to the beneficiary group. This might correspond, for example, to “retro” fishing lures that are no longer in widespread use today.

In addition, or alternatively, the ranking component 116 can use any fusion technique to generate a final set of result items based on the individual result sets shown in FIG. 10. In one case, for example, the ranking component 116 can compute the number of times that each unique search result item appears in the three result sets. The ranking component 116 can then select a subset of the most popular search result items, to produce a final result set. Then, the ranking component 116 can cull out any of the final result items that do not meet the other constraints associated with the query, such as a searcher constraint of “under $5.” The ranking component 116 can then serve the remaining result items to the searcher for his or her consideration. Any other fusion technique can be used instead of the above-described technique. For example, when assessing the relevance of any individual search result item, other fusion techniques can take into consideration whether or not the relevant users have clicked on this result item, the ranking score associated with this result item, and so on.

In yet other cases, the activity-identifying component 114 can use a fuzzy-matching rule to retrieve characteristic information. For example, assume that a query reads, “BBQ equipment for a 53 year old man.” The activity-identifying component 114 can retrieve the characteristic information from the most relevant demographic group in the table pertaining to barbeque, e.g., corresponding to men aged 51-60. But the activity-identifying component 114 can also retrieve characteristic information for the demographic group of men aged 41-50 and the demographic group for men aged 61-70. The activity-identifying component 114 can associate a weight value of 1.0 with the most relevant demographic group (ages 51-60), and can assign a weight value of less than 1.0 to the other demographic groups (to indicate they are somewhat off target). The ranking component 116 can factor this weighting value into its ranking operation, e.g., by suitably discounting the contribution of search result items and queries associated with activity outside the target age group (of 51-60).

The ranking component 116 can identify a subset of ads to present to the searcher in different ways. For example, the ranking component 116 can use the above-identified technique to determine the most prevalent queries and/or search result items for the searcher's query. The ranking component 116 can then feed this information into a machine-trained ad selection model, together with the searcher information and any other constraint specified in the query. The ad selection model processes these inputs to generate an appropriate subset of ads.

For example, assume that the activity information reveals that the relevant users expressed the greatest interest in five retail establishments. But further assume that the searcher information indicates that the searcher is in his early 20s, and therefore may have a modest budget to spend on gifts. As a result the ranking component 116 can choose ads for only those establishments that are within the searcher's presumed budget. The ranking component 116 can also favor those types of ads that have received favorable responses from the searcher on prior occasions.

B. Illustrative Processes

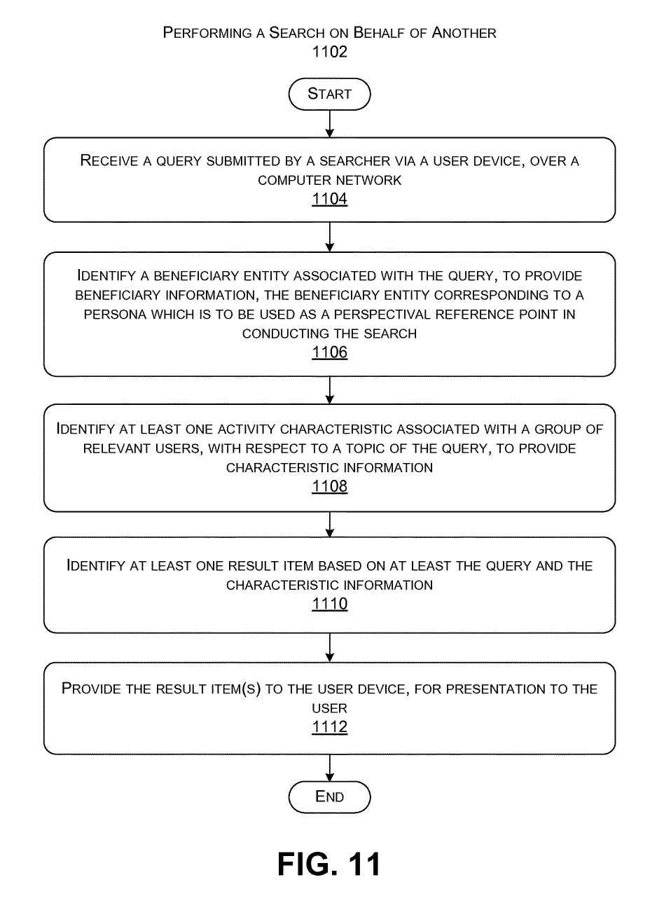

FIG. 11 shows a process 1102 that explains the operation of the system 102 of Section A in flowchart form. Since the principles underlying the operation of the system 102 have already been described in Section A, certain operations will be addressed in summary fashion in this section. As noted in the prefatory part of the Detailed Description, the flowcharts are expressed as a series of operations performed in a particular order. But the order of these operations is merely representative, and can be varied in any manner.

In block 1104, the system 102 receives a query submitted by a searcher via the user device 104 over the computer network 108. In block 1106, the system 102 identifies a beneficiary entity associated with the query, to provide beneficiary information. The beneficiary entity corresponds to a persona which is to be used as a perspectival reference point in conducting the search. In some implementations, the system 102 can identify the beneficiary entity associated with the query by automatically determining whether the query describes the beneficiary entity, either directly or indirectly

In block 1108, the system 102 identifies at least one activity characteristic associated with a group of relevant users, to provide characteristic information. The group of relevant users corresponds to one or more searchers who have a similar demographic profile to the beneficiary entity with respect to a topic of the query. The activity characteristic(s) are based on data provided in at least one data store that reflects previously logged activity of the relevant users in interacting with at least one computer-implemented information system, with respect to the topic of the query.

In block 1110, the system 102 identifies at least one result item based on at least the query and the characteristic information. In block 1112, the system 102 provides the result item(s) to the searcher, for presentation to the searcher via the user device 104. The result item(s) may include any of: search result items, ads, query suggestions, etc.

In some implementations, the system 102 can confirm that the searcher is performing a search on behalf of another person by identifying a demographic profile associated with the searcher, to provide searcher information, and then determining whether the beneficiary information differs from the searcher information.

C. Representative Computing Functionality

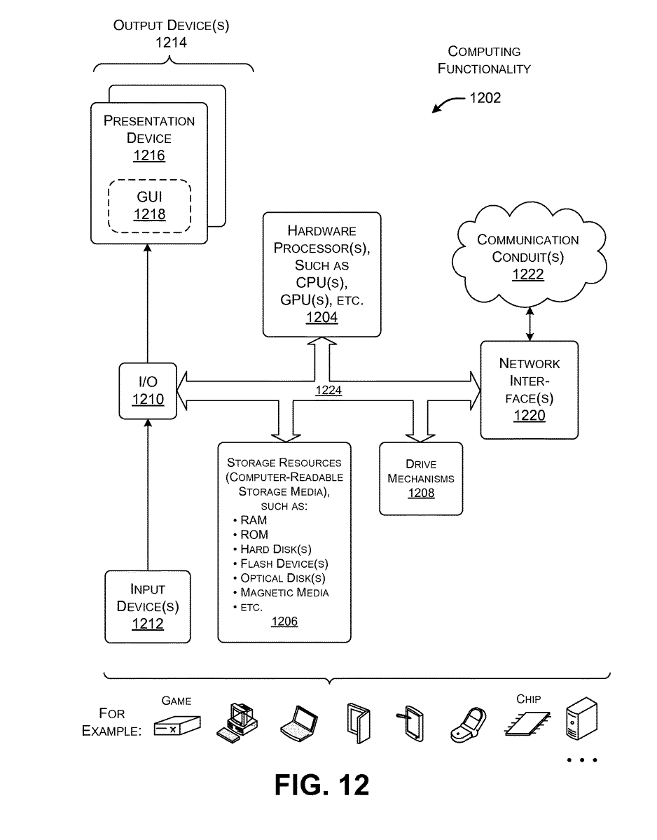

FIG. 12 shows computing functionality 1202 that can be used to implement any aspect of the system 102 set forth in the above-described figures. For instance, the type of computing functionality 1202 shown in FIG. 12 can be used to implement the user device 104 and/or the search engine system 106. In all cases, the computing functionality 1202 represents one or more physical and tangible processing mechanisms.

The computing functionality 1202 can include one or more hardware processors 1204, such as one or more central processing units (CPUs), and/or one or more graphical processing units (GPUs), and so on. The computing functionality 1202 can also include any storage resources (also referred to as computer-readable storage media or computer-readable storage medium devices) 1206 for storing any kind of information, such as machine-readable instructions, settings, data, etc. Without limitation, for instance, the storage resources 1206 may include any of RAM of any type(s), ROM of any type(s), flash devices, hard disks, optical disks, and so on. More generally, any storage resource can use any technology for storing information. Further, any storage resource may provide volatile or non-volatile retention of information. Further, any storage resource may represent a fixed or removable component of the computing functionality 1202. The computing functionality 1202 may perform any of the functions described above when the hardware processor(s) 1204 carry out computer-readable instructions stored in any storage resource or combination of storage resources. The computing functionality 1202 also includes one or more drive mechanisms 1208 for interacting with any storage resource, such as a hard disk drive mechanism, an optical disk drive mechanism, and so on.

The computing functionality 1202 also includes an input/output component 1210 for receiving various inputs (via input devices 1212), and for providing various outputs (via output devices 1214). Illustrative input devices include a keyboard device, a mouse input device, a touchscreen input device, a digitizing pad, one or more video cameras, one or more depth cameras, a free space gesture recognition mechanism, one or more microphones, a voice recognition mechanism, any movement detection mechanisms (e.g., accelerometers, gyroscopes, etc.), and so on. One particular output mechanism may include a presentation device 1216 and an associated graphical user interface presentation (GUI) 1218. The presentation device 1216 may correspond to, for instance, any of a charge-coupled display device, a cathode ray tube device, a projection mechanism, etc. Other output devices include a printer, a model-generating mechanism, a tactile output mechanism, an archival mechanism (for storing output information), and so on. The computing functionality 1202 can also include one or more network interfaces 1220 for exchanging data with other devices via one or more communication conduits 1222. One or more communication buses 1224 communicatively couple the above-described components together.

The communication conduit(s) 1222 can be implemented in any manner, e.g., by a local area computer network, a wide area computer network (e.g., the Internet), point-to-point connections, etc., or any combination thereof. The communication conduit(s) 1222 can include any combination of hardwired links, wireless links, routers, gateway functionality, name servers, etc., governed by any protocol or combination of protocols.

Alternatively, or in addition, any of the functions described in the preceding sections can be performed, at least in part, by one or more hardware logic components. For example, without limitation, the computing functionality 1202 (and its hardware processor) can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc. In this case, the machine-executable instructions are embodied in the hardware logic itself.

The following summary provides a non-exhaustive list of illustrative aspects of the technology set forth herein.

According to a first aspect, a computing device (or devices) is described for allowing a searcher to efficiently access result items. The device includes an interface component configured to receive a query submitted by a searcher via a user device, over a computer network. The device also includes a query analysis component including a beneficiary classifier component and a searcher classifier component. The beneficiary analysis component is configured to identify a beneficiary entity associated with the query by automatically determining whether the query describes the beneficiary entity, to provide beneficiary information, the beneficiary entity corresponding to a persona which is to be used as a perspectival reference point in conducting the search. The searcher classifier component is configured to identify a demographic profile associated with the searcher, to provide searcher information. The beneficiary classifier component is further configured to determine whether the searcher information differs from the beneficiary information, indicating that the searcher is performing a search on behalf of another person

The device further includes an activity-identifying component configured to identify, based on the beneficiary information, characteristic information associated with a group of relevant users, the characteristic information describing at least one search-related activity characteristic of the group of relevant users. The group of relevant users corresponds to one or more searchers who have a similar demographic profile to the beneficiary entity, with respect to the topic of the query. The activity characteristic(s) are based on data provided in at least one data store, and generated by an analysis component, that reflects previously logged activity of the group of relevant users in interacting with at least one computer-implemented information system, with respect to the topic of the query.

The device further includes a ranking component configured to identify at least one result item based on at least the query and the characteristic information. The interface component is further configured to provide the above-referenced at least one result item to the user device.

According to a second aspect, the beneficiary classifier component is configured to identify the beneficiary entity by identifying at least one part of the query that describes the beneficiary entity, using at least one rules-based engine and/or a machine-trained engine.

According to a third aspect, the beneficiary classifier component is configured to identify the beneficiary entity by determining whether the above-referenced at least one part of the query matches a phrase pattern that is associated with a beneficiary entity.

According to a fourth aspect, the above-referenced identifying of the part(s) includes identifying a part of the query which directly refers to a demographic characteristic of the beneficiary entity.

According to a fifth aspect, the above-referenced identifying of the part(s) includes identifying a part of the query which indirectly refers to the beneficiary entity by specifying at least one preference of the beneficiary entity.

According to a sixth aspect, the query analysis component further includes: a topic classifier component configured to identify topic information that describes the topic of the query; and at least one other classifier component configured to identify searcher constraint information which describes one or more preferences specified by the searcher.

According to a seventh aspect, the above-referenced at least one data store provides: information that reflects previously logged activity of individuals in interacting with the above-referenced at least one computer-implemented information system, with respect to a plurality of topics; and information that reflects demographic characteristics associated with the respective individuals.

According to an eighth aspect, the analysis component is further configured to organize the logged activity of the individuals into different demographic groups associated with the individuals, with respect to each of the plurality of topics. The above-referenced organizing uses clustering to identify demographic groups that include collections of individuals who exhibit similar search-related activity.

According to a ninth aspect, the analysis component is further configured to perform operations of: organizing the logged activity of the individuals into different demographic groups associated with the individuals, with respect to each of the plurality of topics; and generating information that indicates an extent to which certain demographic groups submit queries for benefit of other demographic groups.

According to a tenth aspect, the ranking component is configured to perform the operations of: identifying a set of queries submitted by the group of relevant users; identifying an individual result set that contains search result items that are associated with each query in the set of queries; and using a fusion operation to generate a final set of result items based on individual result sets associated with the set of queries.

According to an eleventh aspect, the fusion operation entails selecting a subset of most popular search result items from the individual result sets, to produce the final set of result items.

According to a twelfth aspect, the ranking component is configured to identify the above-referenced at least one result item by a ranking operation that takes into consideration: the characteristic information; the beneficiary information; topic information that describes the topic of the query; the searcher information; and any searcher constraint information which describes one or more preferences specified by the searcher.

According to a thirteenth aspect, the activity-identifying component is further configured to: identify instances of characteristic information associated with two or more relevant groups of users, the groups having varying respective degrees of relevance to the beneficiary entity; and assign a weight to each group based on a degree of relevance of the group to the beneficiary entity. The ranking component is further configured to identify the above-referenced at least one result item by a ranking operation that takes into consideration the weight associated with each group.

According to a fourteenth aspect, a method is described, performed using at least one hardware processor of one or more computing devices, for performing a search. The method includes: receiving a query submitted by a searcher via a user device over a computer network, and then identifying a beneficiary entity associated with the query by automatically determining whether the query describes the beneficiary entity, either directly or indirectly, to provide beneficiary information. The beneficiary entity corresponds to a persona which is to be used as a perspectival reference point in conducting the search. The method then includes identifying characteristic information associated with a group of relevant users, the characteristic information describing at least one search-related activity characteristic of the group of relevant users. The group of relevant users corresponds to one or more searchers who have a similar demographic profile to the beneficiary entity, with respect to a topic of the query. Further, the group of relevant users has a familiarity with respect to the topic of the query that is greater than that possessed by the searcher. Further, the above-referenced activity characteristic(s) are based on data provided in at least one data store that reflects previously logged activity of the group of relevant users in interacting with at least one computer-implemented information system, with respect to the topic of the query. The method next includes identifying at least one result item based on at least the query and the characteristic information, and then providing the above-referenced at least one result item to the user device.

According to a fifteenth aspect, the beneficiary entity is a person to whom the searcher wishes to purchase a gift, and wherein the method further comprises receiving a selection by the searcher of one or more of the above-referenced at least one result item.

According to a sixteenth aspect, the method further includes: identifying a demographic profile associated with the searcher, to provide searcher information; and determining whether the searcher information differs from the beneficiary information, indicating that the searcher is performing a search on behalf of another person.

According to a seventeenth aspect, a computer-readable storage medium is described herein for storing computer-readable instructions. The computer-readable instructions perform operations, when executed by one or more hardware processing devices, that comprise: receiving a query submitted by a searcher via a user device, over a computer network; identifying a beneficiary entity associated with the query, to provide beneficiary information, the beneficiary entity corresponding to a persona which is to be used as a perspectival reference point in conducting the search; identifying a demographic profile associated with the searcher, to provide searcher information; determining whether the searcher information differs from the beneficiary information, indicating that the searcher is performing a search on behalf of another person; and identifying, based on the beneficiary information, characteristic information associated with a group of relevant users, the characteristic information describing at least one search-related activity characteristic of the group of relevant users. The group of relevant users corresponds to one or more searchers who have a similar demographic profile to the beneficiary entity, with respect to a topic of the query. The above-referenced activity characteristic(s) are based on data provided in at least one data store that reflects previously logged activity of the group of relevant users in interacting with at least one computer-implemented information system, with respect to the topic of the query. The method further includes identifying at least one result item based on at least the query and the characteristic information.

According to an eighteenth aspect, the above-referenced at least one data store provides: information that reflects previously logged activity of individuals in interacting with the above-referenced at least one computer-implemented information system, with respect to a plurality of topics; and information that reflects demographic characteristics associated with the respective individuals.

According to a nineteenth aspect, the above-referenced identifying of the characteristic information comprises, preliminarily, organizing the logged activity of the individuals into different demographic groups associated with the individuals, with respect to each of the plurality of topics.

According to a twentieth aspect, the above-referenced organizing comprises using clustering to identify demographic groups that include collections of individuals who exhibit similar search-related activity with respect to each topic under consideration.

A twenty-first aspect corresponds to any combination (e.g., any permutation or subset) of the above-referenced first through twentieth aspects.

A twenty-second aspect corresponds to any method counterpart, device counterpart, system counterpart, means-plus-function counterpart, computer-readable storage medium counterpart, data structure counterpart, article of manufacture counterpart, graphical user interface presentation counterpart, etc. associated with the first through twenty-first aspects.

In closing, the functionality described herein can employ various mechanisms to ensure that any user data is handled in a manner that conforms to applicable laws, social norms, and the expectations and preferences of individual users. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

This description may have described various concepts in the context of illustrative challenges or problems. This manner of explanation does not constitute an admission that others have appreciated and/or articulated the challenges or problems in the manner specified herein.

More generally, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computing devices for allowing a searcher to efficiently access result items, comprising:
an interface component configured to receive a query submitted by a searcher via a user device, over a computer network;
a query analysis component including:
a beneficiary classifier component configured to identify a beneficiary entity associated with the query by automatically determining whether the query describes the beneficiary entity, to provide beneficiary information, the beneficiary entity corresponding to a persona which is to be used as a perspectival reference point in conducting the search;
a search classifier component configured to identify a demographic profile associated with the searcher, to provide searcher information,
the beneficiary classifier component further being configured to determine whether the searcher information differs from the beneficiary information, indicating that the searcher is performing a search on behalf of another person;
an activity-identifying component configured to identify, based on the beneficiary information, characteristic information associated with a group of relevant users, the characteristic information describing at least one search-related activity characteristic of the group of relevant users,
the group of relevant users corresponding to one or more searchers who have a similar demographic profile to the beneficiary entity, with respect to the topic of the query,
said at least one activity characteristic being based on data provided in at least one data store, and generated by an analysis component, that reflects previously logged activity of the group of relevant users in interacting with at least one computer-implemented information system, with respect to the topic of the query; and
a ranking component configured to identify at least one result item based on at least the query and the characteristic information,
the interface component further being configured to provide said at least one result item to the user device.

2. The one or more computing devices of claim 1, wherein the beneficiary classifier component is configured to identify the beneficiary entity by identifying at least one part of the query that describes the beneficiary entity, using at least one rules-based engine and/or a machine-trained engine.

3. The one or more computing devices of claim 2, wherein the beneficiary classifier component is configured to identify the beneficiary entity by determining whether said at least one part of the query matches a phrase pattern that is associated with a beneficiary entity.

4. The one or more computing devices of claim 2, wherein said identifying of said at least one part includes identifying a part of the query which directly refers to a demographic characteristic of the beneficiary entity.

5. The one or more computing devices of claim 2, wherein said identifying of said at least one part includes identifying a part of the query which indirectly refers to the beneficiary entity by specifying at least one preference of the beneficiary entity.

6. The one or more computing devices of claim 1, wherein the query analysis component further includes:
a topic classifier component configured to identify topic information that describes the topic of the query; and
at least one other classifier component configured to identify searcher constraint information which describes one or more preferences specified by the searcher.

7. The one or more computing devices of claim 1, wherein said at least one data store provides:
information that reflects previously logged activity of individuals in interacting with said at least one computer-implemented information system, with respect to a plurality of topics; and
information that reflects demographic characteristics associated with the respective individuals.

8. The one or more computing devices of claim 7, wherein the analysis component is further configured to perform operations of:
organizing the logged activity of the individuals into different demographic groups associated with the individuals, with respect to each of the plurality of topics,
said organizing using clustering to identify demographic groups that include collections of individuals who exhibit similar search-related activity.

9. The one or more computing devices of claim 7, wherein the analysis component is further configured to perform operations of:
organizing the logged activity of the individuals into different demographic groups associated with the individuals, with respect to each of the plurality of topics; and
generating information that indicates an extent to which certain demographic groups submit queries for benefit of other demographic groups.

10. The one or more computing devices of claim 1, wherein the ranking component is configured to perform the operations of:
identifying a set of queries submitted by the group of relevant users;
identifying an individual result set that contains search result items that are associated with each query in the set of queries; and
using a fusion operation to generate a final set of result items based on individual result sets associated with the set of queries.

11. The one or more computing device of claim 10, wherein the fusion operation entails selecting a subset of most popular search result items from the individual result sets, to produce the final set of result items.

12. The one or more computing devices of claim 1, wherein the ranking component is configured to identify said at least one result item by a ranking operation that takes into consideration:
the characteristic information;
the beneficiary information;
topic information that describes the topic of the query;
the searcher information; and
any searcher constraint information which describes one or more preferences specified by the searcher.

13. The one or more computing devices of claim 1,
wherein the activity-identifying component is further configured to:
identify instances of characteristic information associated with two or more relevant groups of users, the groups having varying respective degrees of relevance to the beneficiary entity; and
assign a weight to each group based on a degree of relevance of the group to the beneficiary entity, and
wherein the ranking component is configured to identify said at least one result item by a ranking operation that takes into consideration the weight associated with each group.

14. A method, performed using at least one hardware processor of one or more computing devices, for performing a search, comprising:
receiving a query submitted by a searcher via a user device over a computer network;
identifying a beneficiary entity associated with the query by automatically determining whether the query describes the beneficiary entity, either directly or indirectly, to provide beneficiary information, the beneficiary entity corresponding to a persona which is to be used as a perspectival reference point in conducting the search;
identifying characteristic information associated with a group of relevant users, the characteristic information describing at least one search-related activity characteristic of the group of relevant users,
the group of relevant users corresponding to one or more searchers who have a similar demographic profile to the beneficiary entity, with respect to a topic of the query,
the group of relevant users having a familiarity with respect to the topic of the query that is greater than that possessed by the searcher, and
said at least one activity characteristic being based on data provided in at least one data store that reflects previously logged activity of the group of relevant users in interacting with at least one computer-implemented information system, with respect to the topic of the query;
identifying at least one result item based on at least the query and the characteristic information; and
providing said at least one result item to the user device.

15. The method of claim 14, wherein the beneficiary entity is a person to whom the searcher wishes to purchase a gift, and wherein the method further comprises receiving a selection by the searcher of one or more of said at least one result item.

16. The method of claim 14, further including:
identifying a demographic profile associated with the searcher, to provide searcher information; and
determining whether the searcher information differs from the beneficiary information, indicating that the searcher is performing a search on behalf of another person.

17. A computer-readable storage medium for storing computer-readable instructions, the computer-readable instructions performing operations, when executed by one or more hardware processing devices, that comprise:
receiving a query submitted by a searcher via a user device, over a computer network;
identifying a beneficiary entity associated with the query, to provide beneficiary information, the beneficiary entity corresponding to a persona which is to be used as a perspectival reference point in conducting the search;
identifying a demographic profile associated with the searcher, to provide searcher information;
determining whether the searcher information differs from the beneficiary information, indicating that the searcher is performing a search on behalf of another person;
identifying, based on the beneficiary information, characteristic information associated with a group of relevant users, the characteristic information describing at least one search-related activity characteristic of the group of relevant users,
the group of relevant users corresponding to one or more searchers who have a similar demographic profile to the beneficiary entity, with respect to a topic of the query, and
said at least one activity characteristic being based on data provided in at least one data store that reflects previously logged activity of the group of relevant users in interacting with at least one computer-implemented information system, with respect to the topic of the query; and
identifying at least one result item based on at least the query and the characteristic information.

18. The computer-readable storage medium of claim 17, wherein said at least one data store provides:
information that reflects previously logged activity of individuals in interacting with said at least one computer-implemented information system, with respect to a plurality of topics; and
information that reflects demographic characteristics associated with the respective individuals.

19. The computer-readable storage medium of claim 18, wherein said identifying of the characteristic information comprises, preliminarily, organizing the logged activity of the individuals into different demographic groups associated with the individuals, with respect to each of the plurality of topics.

20. The computer-readable storage medium of claim 19, wherein said organizing comprises using clustering to identify demographic groups that include collections of individuals who exhibit similar search-related activity with respect to each topic under consideration.
